(19) United States
(12) Patent Application Publication
(10) Pub. No.: US 2009/0032555 A1
(43) Pub. Date: Feb. 5, 2009

(54) Feeder

(76) Inventor: Fred Cornell Peterson, North Branch, MN (US)

Correspondence Address: MERCHANT & GOULD PC, P.O. BOX 2903, MINNEAPOLIS, MN, 55402-0903, US

(21) Appl. No.: 12/183,160

(22) Filed: Jul. 31, 2008

Related U.S. Application Data
(60) Provisional application No. 60/953,047, filed on Jul. 31, 2007.

(51) Int. Cl. G01F 11/00; B65D 88/66; G01F 11/20

(52) U.S. Cl. 222/226; 222/196; 222/412

(57) ABSTRACT

A feeder is configured to dispense particulate material at a desired rate. The feeder can include a discharge system that allows for the particulate material to be removed from the feeder in an efficient manner. The feeder can include a roller that assists in the agitation of the hopper to facilitate dispensing of the particulate material.

### RELATED APPLICATION

This application claims the benefit of U.S. Patent Application Ser. No. 60/953,047 filed on Jul. 31, 2007, the entirety of which is hereby incorporated by reference.

### BACKGROUND

Dry good material feeders commonly include a hopper having an inclined storage area and a lower cylindrical portion for housing a rotating auger. The rotating auger conveys dry particulate material, such as a powdered food product, from the inclined holding area, through a cylindrical passage, to a space outside of the hopper. A drive assembly is typically provided for the auger at the end of the auger which is opposite from the housing opening through which the dry material is conveyed. Examples of such feeders are disclosed in U.S. Pat. Nos. 5,263,572 and 5,516,009 to Tecnetics Industries, Inc. of St. Paul, Minn., which is the assignee of this application.

### SUMMARY

The present disclosure relates to feeders. The feeder is configured to dispense particulate material at a desired rate. In example embodiments, the feeder includes a discharge system that allows for the particulate material to be removed from the feeder in an efficient manner. In other embodiments, the feeder includes a roller that assists in the agitation of the hopper to facilitate dispensing of the particulate material.

### DESCRIPTION OF THE DRAWINGS

Reference is now made to the accompanying drawings, which are not necessarily drawn to scale.

FIG. 1 is a perspective view of an example embodiment of a feeder.

FIG. 2 is an exploded perspective view of the feeder of FIG. 1.

FIG. 3 is an exploded perspective view of a cabinet, hopper and discharge system of the feeder of FIG. 1.

FIG. 4 is a perspective view of the cabinet and internal components of the feeder of FIG. 1 with a wall of the cabinet removed for purposes of clarity.

FIG. 5 is a front view of the cabinet of the feeder of FIG. 1.

FIG. 6 is a cross-sectional view taken along line 6-6 of the cabinet of FIG. 5.

FIG. 7 is a side view of the cabinet of FIG. 5.

FIG. 8 is a cross-sectional view taken along line 8-8 of the cabinet of FIG. 7.

FIG. 9 is a bottom view of the cabinet of FIG. 5.

FIG. 10 is a cross-sectional view of another example cabinet of a feeder.

### DETAILED DESCRIPTION

Example embodiments will now be described more fully hereinafter with reference to the accompanying drawings. These embodiments are provided so that this disclosure will be thorough and complete. Like numbers refer to like elements throughout.

The present disclosure relates to feeders. The feeder is configured to dispense particulate material at a desired rate. In example embodiments, the feeder includes a discharge system that allows for the particulate material to be removed from the feeder in an efficient manner. In other embodiments, the feeder includes a roller that assists in the agitation of the hopper to facilitate dispensing of the particulate material.

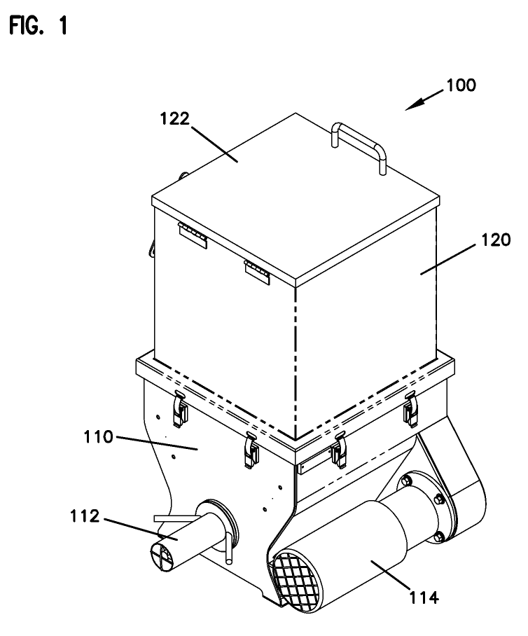

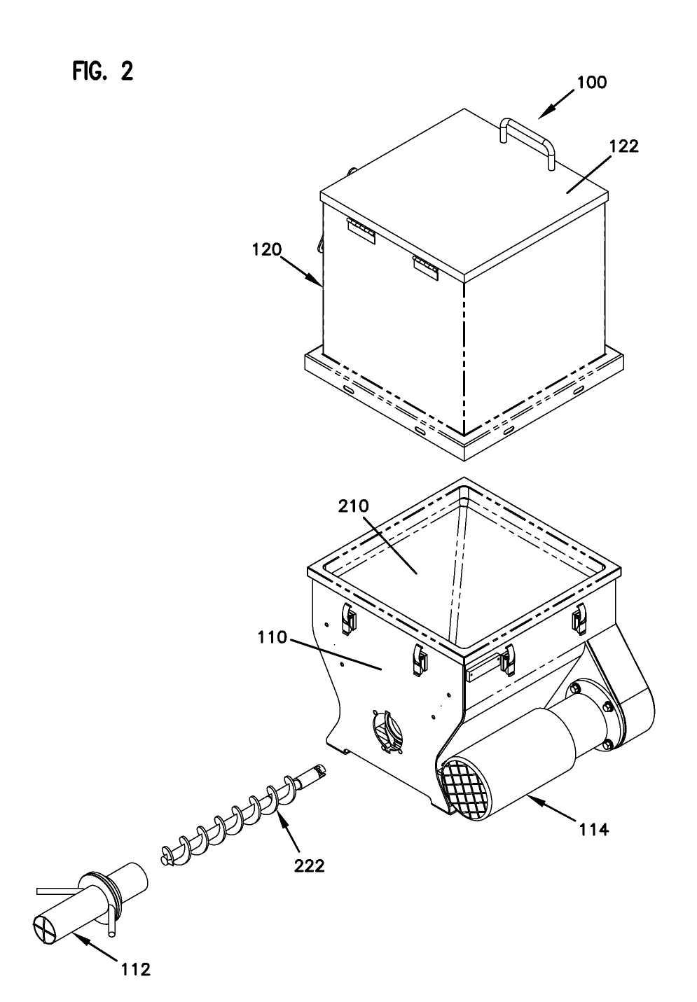

Referring now to FIGS. 1-3, an example embodiment of a feeder 100 is shown. In example embodiments, the feeder 100 is a volumetric feeder that allows for the precise dispensing of particulate material. The feeder 100 includes a cabinet 110, a feed tube 112, and a drive motor 114. In the example shown, the feeder 100 also includes an extension hopper 120 with a hinged lid 122.

The cabinet 110 typically forms an enclosed structure into which a hopper 210 is positioned. In example embodiments, the hopper 210 is a flex-feed hopper that is semi-flexible, although other configurations are possible. The hopper 210 includes inclined walls 211, 213, 215, 217 that form an enclosure 310 into which particulate material is positioned. In example embodiments, the particulate material includes a wide variety of dry materials, from powders to large pellets. The particulate material can be dispensed at different rates including, for example, from 0.003 cubic feet per hour up to more than 900 cubic feet per hour.

The hopper 210 forms an exit opening 320 through which the particulate material is discharged, as described below. The hopper 210 also includes a dispense opening 330 through which the particulate material is dispensed.

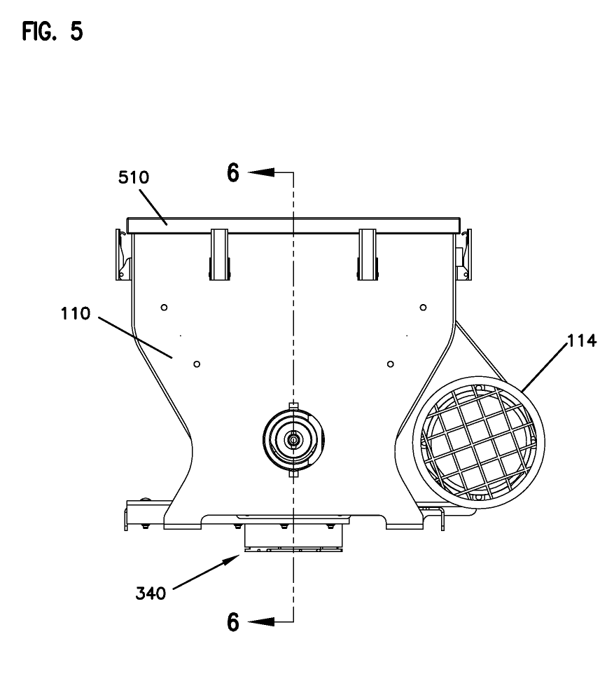

In some embodiments, the extension hopper 120 is coupled to the cabinet 110 to provide additional storage for the particulate material prior to dispensing. The hinged lid 122 can be pivoted from a closed position to an open position to access the particulate material stored in the extension hopper 120. If the extension hopper 120 is not used, a lid (see, e.g., a lid 510 of FIG. 5) can be attached to the cabinet 110 to close the hopper 210.

In example embodiments, the drive motor 114 is an electric motor. In some embodiments, the drive motor 114 is a 0-90 VDC motor with SCR control, although other configurations are possible.

An auger 222 extends from the dispense opening 330 into the feed tube 220. The auger 222 is rotated by the drive motor 114, as described below. As the auger 222 is rotated, the particulate material that is located in the enclosure 310 of the hopper 210 is moved by the auger 222 through the dispense opening 330 and out the feed tube 112.

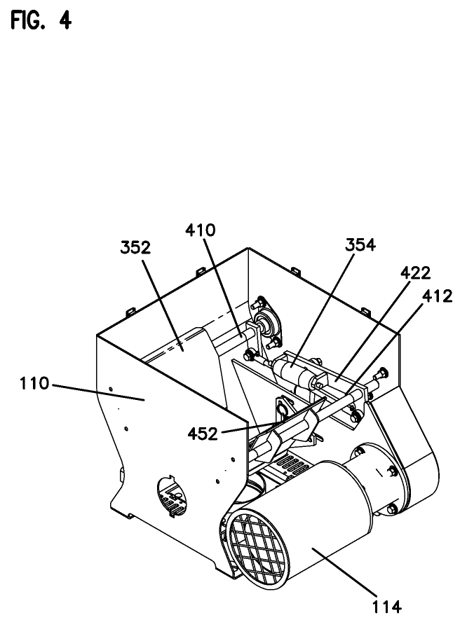

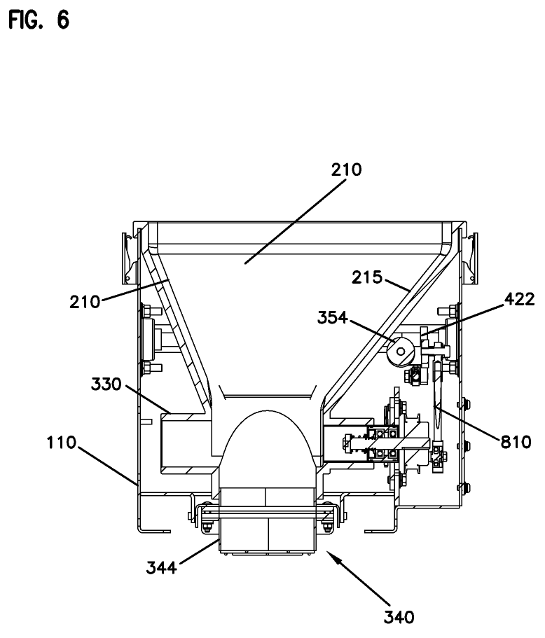

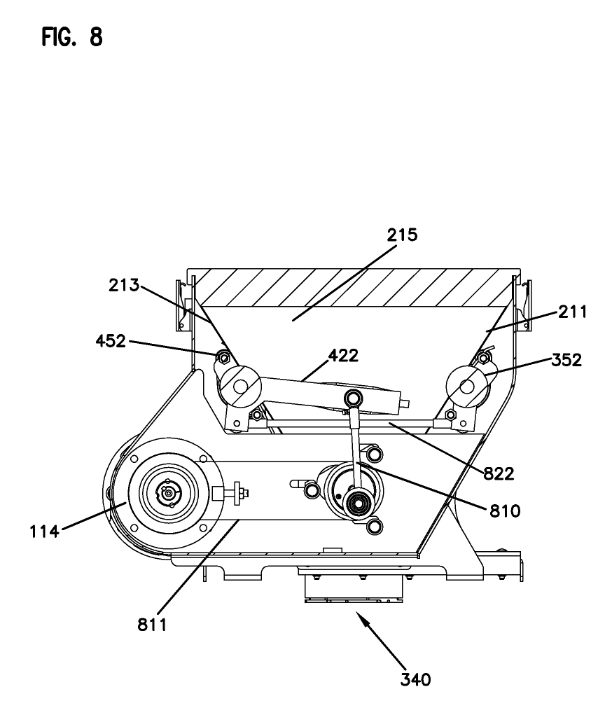

Referring now to FIGS. 4, 6, and 8, paddles 352, 452 are positioned within the cabinet 110 adjacent to the walls 211, 213 of the hopper 210. The paddles 352, 452 are coupled to the drive motor 114 by a belt 811, a linkage 810, and a bar 422. The belt 811, which can be a cogged or synchronous belt, couples the linkage 810 to the drive motor 114. The linkage 810 is, in turn, coupled in an offset manner with the bar 422 that extends to a member 412 that is coupled to the paddle 452. The paddle 452 is, in turn, connected to the paddle 352 by a bar 822 and a member 410 that is coupled to the paddle 352.

As the drive motor 114 rotates, the belt 811 rotates the linkage 810. The linkage 810, in turn, moves the bar 422 generally in a vertical direction. As the bar 422 is moved, the member 412 is rotated, which also rotates the paddle 452. As the paddle 452 moves, the bar 822 is moved, thereby causing the paddle 352 and a member 410 coupled thereto to rotate.

As the paddles 352, 452 are rotated, the paddles 352, 452 periodically contact the walls 211, 213 of the hopper 210 to provide agitation. This agitation assists in moving the particulate material downward through the dispense opening 330. The agitation helps to minimize undesired degrading, rat holing, bridging and compacting of the particulate material as it is dispensed.

A roller 354 is positioned to contact the rear wall 215 of the hopper 210. The roller 354 is coupled to the bar 422. Therefore, as the bar 422 is moved generally vertically by the linkage 810, the roller 354 also moves up and down. The roller 354 defines a generally round outer circumference such that the roller 354 contacts and rolls along the rear wall 215 of the hopper 210 as the roller 354 is moved generally vertically. This movement also provides agitation of the particulate material in the hopper 210.

In this manner, the paddles 352, 452 and the roller 354 function to agitate the walls 211, 213, and the rear wall 215 so that the resulting agitation improves the dispensing of the particulate material in the hopper. Such a configuration results in agitation of three of the four walls of the hopper 210 (i.e., the two opposing walls and the rear wall). In an alternative embodiment, another roller is positioned to agitate the front wall 217 of the hopper 210 so that agitation is provided for all of the walls of the hopper 210. In yet other alternative embodiments, one or both of the paddles are replaced by rollers, or the roller located at the rear wall can be replaced by a paddle.

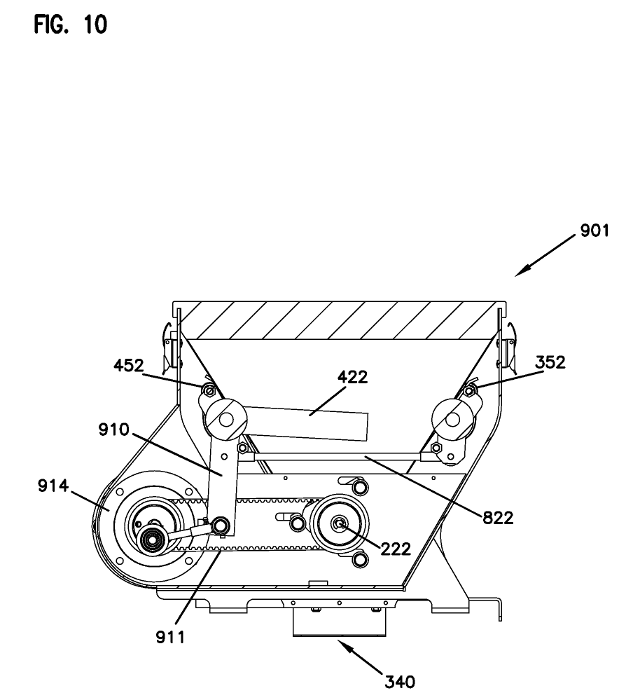

Other alternative designs are possible. One alternative embodiment is shown in FIG. 10, which is described below. In another alternative embodiment, a separate motor is used to move the paddles 352, 452 and the roller 354. In one example, the separate motor is connected to the paddles 352, 452 and the roller 354 using a cam. In other embodiments, the belt 811 is replaced with sprockets and a roller chain drive.

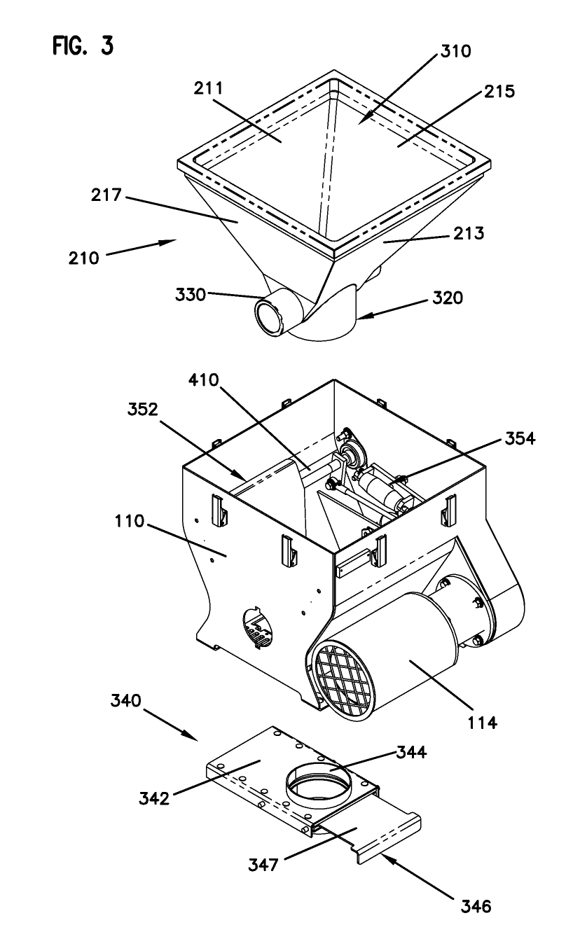

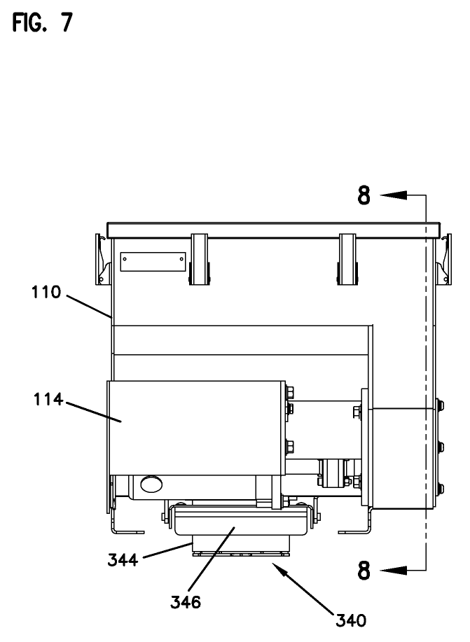

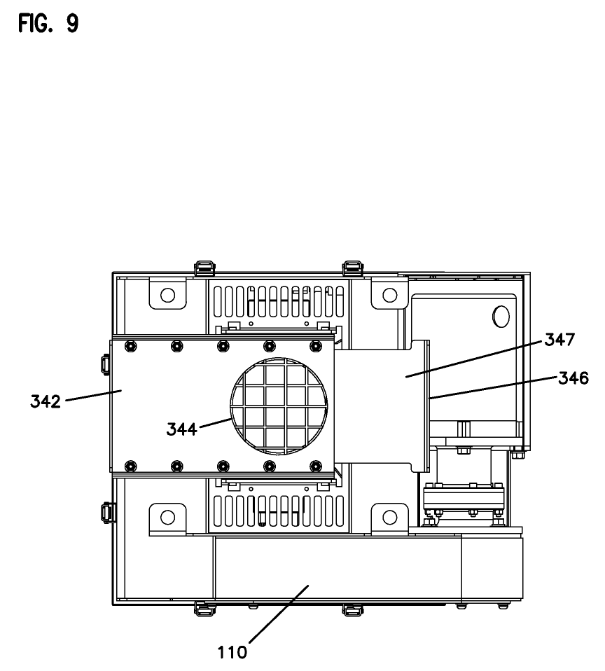

Referring now to FIGS. 3, and 5-9, in some embodiments, an example discharge system 340 is coupled to the bottom of the cabinet 110. The discharge system 340 includes a main body 342, a discharge opening 344 extending through the main body 342, and a slide gate 346. The slide gate 346 slides into and out of the main body 342 between closed and open configurations. In the closed configuration with the slide gate 346 slid into the main body 342, a surface 347 of the slide gate 346 blocks or otherwise closes the discharge opening 344. In the open configuration as shown in FIGS. 3 and 9, the surface 347 of the slide gate 346 slides out of the main body 342 so that the surface 347 no longer blocks the discharge opening 344.

When the hopper 210 is placed into the cabinet 110, the exit opening 320 of the hopper 210 is positioned over the discharge opening 344 of the discharge system 340 so that the exit opening 320 and the discharge opening 344 are in fluid communication. With the slide gate 346 in the closed configuration, the surface 347 of the slide plate 346 blocks the exit opening 320 of the hopper 210 so that particulate material positioned within the enclosure 310 of the hopper 210 is maintained within the hopper 210.

To remove the particulate material remaining in the hopper 210, the slide gate 346 is moved to the open configuration such that the surface 347 is removed from the discharge opening 344 so that the particulate material within the enclosure 310 is moved downwardly by gravity (and possibly the agitation effects of the paddles and roller, as described further below) through the exit opening 320 and the discharge opening 344 and out of the hopper 210. A container (not shown) can be positioned below the discharge opening 344 to capture the particulate material as it exits the discharge opening 344. It may be desirable to open the discharge opening 344, for example, when it is necessary to cleanse the hopper and/or change the particulate material in the hopper 210 that is being dispensed by the feeder 100.

In some embodiments, the drive motor 114 can be reversed to rotate the auger 222 in the reverse direction to move any remaining particulate material within the feed tube 112 back into the hopper 210 and out the exit opening 320 and the discharge opening 344. Further, in some embodiments, the drive motor 114 can also be used to move the paddles 352, 452 and/or the roller 354 to agitate the hopper 210 to further assist in the removal of the particulate material from the hopper 210.

In this manner, the particulate material can be efficiently removed from the hopper 210. After removal of the particulate, the hopper and the feed tube can be cleansed, and the slide plate 346 can be moved back to the closed position to close the discharge opening 344. At this point, new particulate material can be placed into the hopper 210 for dispensing.

Other embodiments are possible. For example, in some alternatives, the slide gate 340 can be replaced with other designs, such as a valve structure such as a butterfly valve, a pneumatic valve, a hydraulic valve, an electromechanical valve, or a diverter valve. In other examples, the slide gate 340 can be replaced by a removable plug that is removed when removal of the particulate material from the hopper 210 is desired.

An example method of using the feeder 100 is as follows. Initially, the particulate material is positioned within the hopper. Next, the drive motor is turned on so that the particulate material is dispensed by the auger out of the feed tube at the desired rate. Also, the drive motor moves the paddles and roller to agitate the hopper to minimize bridging of the particulate material.

Next, when it is time to cleanse the hopper and/or to change the particulate material that is being dispensed, the drive motor is reversed, and the discharge opening is opened. This allows the particulate material to be discharged from the hopper. The hopper and auger are then disassembled from the cabinet. Next, the hopper and the feed tube are cleansed. Finally, the discharge opening is closed, the hopper and auger are reassembled, and new particulate can be added to the hopper.

Referring now to FIG. 10, another example embodiment of a cabinet 901 of a volumetric feeder is shown. The cabinet 901 is similar to the cabinet of the feeder 100 described above. However, the cabinet 901 includes a modified drive arrangement including a linkage 910 that connects a motor 914 to the paddles 352, 452, and belt 911 that connects the motor 914 to drive the auger 222.

As the drive motor 914 rotates, the linkage 910 rotates the paddle 452. As the paddle 452 moves, the bar 822 is moved, thereby causing the paddle 352 and a member 410 coupled thereto to rotate. As the paddles 352, 452 are rotated, the paddles 352, 452 periodically contact the walls 211, 213 of the hopper 210 to provide agitation. This agitation assists in moving the particulate material downward through the dispense opening 330.

Also, the belt 911 is driven by the motor 914 to rotate the auger 222. As the auger 222 is rotated, the particulate material that is located in the enclosure 310 of the hopper 210 is moved by the auger 222 through the dispense opening 330 and out the feed tube 112.

When it is time to cleanse the hopper and/or to change the particulate material that is being dispensed, the drive motor 914 is reversed, and the discharge opening 340 is opened. The motor 914 moves the paddles 352, 452 and/or the roller 354 to agitate the hopper to assist in the removal of the particulate material through the discharge opening 340. In addition, the belt 911 is coupled to the motor 914 with a one-way clutch so that, when the motor 914 is reversed, the belt 911 is not driven by the motor. This stops the auger 222 from turning in the reverse direction, which minimizes the possibility of the auger packing material into the bottom opening and thereby stopping the material from discharging.

In example embodiments, the cabinet, auger, feed tube, and discharge system are made of a rigid material such as stainless steel. In example embodiments, the paddles and roller are made of a rigid material, such as stainless steel. The hopper is made of a semi-flexible material, such as polyurethane or vinyl.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A volumetric feeder, comprising:
a cabinet;
a hopper positioned in the cabinet, the hopper defining a dispense opening and an exit opening;
a feed tube connected to the dispense opening;
an auger positioned within the feed tube;
a motor to rotate the auger to dispense particulate material through the dispense opening and the feed tube; and
a discharge system coupled to the cabinet, the discharge system defining a discharge opening in communication with the exit opening such that the particulate material discharges from the hopper when the discharge opening is opened.

2. The feeder of claim 1, further comprising:
opposing members positioned in the cabinet to agitate first and second walls of the hopper; and
a roller positioned in the cabinet to agitate a third wall of the hopper;
wherein the motor moves the members and the roller to agitate the first, second, and third walls of the hopper.

3. The feeder of claim 2, further comprising a slide plate that moves with respect to the hopper to open and close the discharge opening, wherein the hopper further defines an exit opening in communication with the discharge opening such that the particulate material discharges from the hopper when the slide plate is moved to open the discharge opening.

4. The feeder of claim 1, further comprising a slide plate that moves with respect to the hopper to open and close the discharge opening, wherein the hopper further defines an exit opening in communication with the discharge opening such that the particulate material discharges from the hopper when the slide plate is moved to open the discharge opening.

5. A volumetric feeder, comprising:
a cabinet;
a hopper positioned in the cabinet, the hopper including at least three walls, and the hopper defining a dispense opening;
a feed tube connected to the dispense opening;
an auger positioned within the feed tube;
opposing paddles positioned in the cabinet to agitate at least two of the three walls of the hopper;
a roller positioned in the cabinet to agitate another of the three walls of the hopper; and
a motor to rotate the auger to dispense particulate material through the dispense opening and the feed tube, and to move the paddles and the roller to agitate the three walls of the hopper.

6. The feeder of claim 5, further comprising a discharge system coupled to the cabinet, the discharge system comprising a main body defining a discharge opening, and a slide plate that moves with respect to the main body to open and close the discharge opening, wherein the hopper further defines an exit opening in communication with the discharge opening such that the particulate material discharges from the hopper when the slide plate is moved to open the discharge opening.

7. A method for feeding particulate material, the method comprising:
rotating the auger in a first direction to dispense the particulate material from a hopper at a desired rate;
moving at least one paddle to periodically contact the hopper to provide agitation of the particular material; and
moving at least one roller along the hopper to provide agitation of the particulate material in the hopper.

8. The method of claim 7, further comprising:
rotating the auger in a second direction;
opening the discharge opening;
discharging the particulate material from the hopper through the discharge opening.

9. The method of claim 8, further comprising:
disassembling the hopper and the auger; and
cleaning the hopper.

10. The method of claim 8, further comprising moving the paddle and the roller to agitate the particulate material to assist in discharging the particular material.

11. The method of claim 7, further comprising positioning the particulate material in the hopper.

12. The method of claim 7, wherein moving the roller further comprises moving the roller generally vertically along a wall of the hopper.
